(19) United States
(12) Patent Application Publication
(10) Pub. No.: US 2011/0247606 A1
(43) Pub. Date: Oct. 13, 2011

(54) FLUID SULFUR WITH IMPROVED VISCOSITY AS A HEAT CARRIER

(75) Inventors: Felix Major, Mannheim (DE); Fabian Seeler, Dossenheim (DE); Florian Garlichs, Neustadt (DE); Martin Gärtner, Worms (DE); Stephan Maurer, Neustadt-Gimmeldingen (DE); Jürgen Wortmann, Limburgerhof (DE); Michael Lutz, Speyer (DE); Günther Huber, Ludwigshafen (DE); Otto Machhammer, Mannheim (DE); Kerstin Schierle-Arndt, Zwingenberg (DE)

(73) Assignee: BASF SE, Ludwigshafen (DE)

(21) Appl. No.: 13/082,585

(22) Filed: Apr. 8, 2011

Related U.S. Application Data
(60) Provisional application No. 61/322,311, filed on Apr. 9, 2010.

(51) Int. Cl. F24J 2/48; F24J 2/04; C09K 5/00

(52) U.S. Cl. 126/679; 252/71

(57) ABSTRACT

Mixture comprising elemental sulfur and an additive comprising anions.

The present invention relates to a mixture comprising elemental sulfur and an additive comprising anions, to a process for preparing a mixture comprising elemental sulfur and an additive comprising anions, to the use of a mixture comprising elemental sulfur and an additive comprising anions as a heat carrier and/or heat accumulator, and to heat carriers and/or heat accumulators which comprise a mixture comprising elemental sulfur and an additive comprising anions, and to solar thermal power plants comprising pipelines, heat exchangers and/or vessels filled with mixtures comprising elemental sulfur and an additive comprising anions, each as defined in the claims.

According to the field of use, the profile of requirements for heat carrier or heat accumulator fluids varies to a very high degree, and a multitude of fluids are therefore used in practice. The fluids should be liquid and have low viscosities at room temperature or even lower temperatures. Water is no longer an option for relatively high use temperatures; its vapor pressure would be too great. Therefore, hydrocarbon-based mineral oils are used up to approximately 320° C., and synthetic aromatics-containing oils or silicone oils for temperatures up to 400° C. (Verein Deutscher Ingenieure, VDI-Gesellschaft Verfahrenstechnik and Chemieingenieurwesen (GVC), VDI Wärmeatlas, 10th edition, Springer Verlag Berlin Heidelberg, 2006).

A recent application for heat carrier fluids is that of thermal solar power plants which generate electrical energy on a large scale indirectly from solar radiation (Butscher, R., Bild der Wissenschaft 2009, 3, pages 84 to 92).

This involves focusing the solar radiation, for example by means of parabolically shaped mirror troughs, into the focus line of mirrors. At the focus line is a metal tube, which may be within a glass tube to prevent heat losses, the space between the concentric tubes having been evacuated. A heat carrier fluid, which is heated by the solar radiation, flows through the metal tube. One example of a heat carrier fluid currently being used is a mixture of diphenyl ether and diphenyl.

In this way, the heat carrier is heated to a maximum of 400° C. by the focused solar radiation. The hot heat carrier heats water to steam in a steam generator. This steam drives a turbine, and this in turn drives, as in a conventional power plant, the generator for power generation.

This process can achieve an average efficiency of approximately 16 percent based on the energy content of the solar radiation. The efficiency of the steam turbine at this inlet temperature is approximately 37 percent.

To date, such power plants have been built with an installed power of several hundred megawatts, and many others are being planned, especially in Spain, but also in North Africa and the USA.

Both constituents of the mixture of diphenyl ether and diphenyl used as the heat carrier (this mixture is referred to hereinafter as “thermal oil”) boil at approximately 256° C. under standard pressure. The melting point of the diphenyl is 68-72° C., and that of the diphenyl ether 26-39° C. The mixing of the two substances lowers the melting point to 12° C. The mixture of the two substances can be used up to a maximum of 400° C.; decomposition occurs a higher temperatures. The vapor pressure is about 10 bar at this temperature, a pressure which is still tolerable in industry.

It is desirable to obtain higher turbine efficiencies than 37 percent. However, higher steam inlet temperatures than 400° C. are necessary for this purpose.

The efficiency of a steam turbine rises with the turbine inlet temperature. Modern fossil-fired power plants work with steam inlet temperatures up to 650° C. and thus achieve efficiencies around 45%.

It would also be entirely technically possible in solar thermal power plants to heat the heat carrier fluid to temperatures around 650° C. in the focus line of the mirrors, and hence likewise to achieve such high efficiencies as in fossil-fired power plants; however, this is prevented by the limited thermal stability of the heat carrier fluid currently being used.

Higher temperatures than in parabolic trough power plants can be achieved in solar thermal tower power plants, in which a tower is surrounded by mirrors which focus the sunlight onto a receiver in the upper part of the tower. In this receiver, a heat carrier is heated, and is then used, via a heat exchanger, to raise steam and to operate a turbine. In tower power plants (for example Solar II, California, USA), a mixture of sodium nitrate (NaNO₃) and potassium nitrate (KNO₃) (60:40) has already been used as a heat carrier. This mixture can be used up to 550° C. without any problem, but has a very high melting point of 240° C., i.e. the mixture solidifies below this temperature and can thus no longer circulate in lines as a heat carrier.

A further possible high-temperature heat carrier proposed has been one based on sulfur. Sulfur melts at 120° C. under standard pressure and boils at 440° C. under standard pressure. Liquid sulfur is, however, problematic as a heat carrier since it is generally highly viscous and not pumpable within the temperature range from 160 to 220° C.

It is therefore desirable to lower the viscosity of molten sulfur.

To reduce the viscosity of sulfur melts, WO 2005/071037 describes mixing the sulfur with small portions of selenium and/or tellurium. U.S. Pat. No. 4 335 578 describes reducing the viscosity of sulfur melts by additions of bromine or iodine.

However, all these additives are already highly corrosive at low temperatures, and even more so at the high temperatures of the sulfur melt.

It is advantageous to operate a solar thermal power plant continuously. This is achieved, for example, by storing heat during times of high solar radiation, which can be used for power production after sunset or during periods of poor weather.

Heat can be stored directly by storage of the heated heat carrier medium in well-insulated reservoir tanks, or indirectly by transfer of the heat from the heated heat carrier medium to another medium (heat accumulator), for example a sodium nitrate-potassium nitrate salt melt.

An indirect method has been implemented in the 50 MW Andasol I power plant in Spain, wherein approx. 28 000 t of a melt of sodium nitrate and potassium nitrate (60:40) are used as a heat accumulator in a well-insulated tank. During the periods of solar radiation, the melt is pumped from a colder tank (approximately 280° C.) through a thermal oil-salt heat exchanger into a hotter tank, and is heated to about 380° C. in the process. By means of a heat exchanger, thermal energy is removed from the thermal oil and introduced into the salt melt (thermal oil-salt heat exchanger). In periods of low solar radiation and at night, the power plant can be operated under full load for about 7.5 h with a fully charged accumulator.

However, it would be advantageous also to use the heat carrier medium as a heat accumulator medium, since the corresponding thermal oil-salt heat exchangers could thus be dispensed with.

Moreover, in this way, possible contact of the thermal oil having reducing properties with the strongly oxidizing nitrate melt could be avoided. Owing to the much higher cost of the thermal oil compared to the sodium nitrate-potassium nitrate melt, thermal oil has to date not been considered as a heat accumulator.

It is an object of the invention to provide a readily available, improved heat carrier and heat accumulator substance, preferably heat carrier and heat accumulator fluid. The fluid should be usable at higher temperatures than 400° C., preferably above 500° C. At the same time, the melting point should be lower than that of known inorganic salt melts already used in industry, for example below 130° C. The fluid should additionally have an industrially tolerable, very low vapor pressure, preferably lower than 10 bar.

In principle, any kind of elemental sulfur is of good suitability for the present invention. Elemental sulfur has been known since antiquity and is described, for example, in Gmelins Handbuch der Anorganischen Chemie [Gmelin's Handbook of Inorganic Chemistry] (8th edition, Verlag Chemie GmbH, Weinheim, 1953). It can be obtained from native sources, sulfidic ores or by the Frasch process, but is also obtained in a large amount in the desulfurization of mineral oil and natural gas.

Sulfur with good suitability has a purity in the range from 98 to 100% by weight, preferably in the range from 99.5 to 100% by weight. The difference from 100% by weight is, depending on the method by which it is obtained, typically water, inorganic minerals or hydrocarbons.

Additives comprising anions in the context of this application are compounds of a metal of the Periodic Table of the Elements with monoatomic or polyatomic, formally singly or multiply negatively charged anions, preferably anions formed from nonmetal atoms.

Examples of such metals are: alkali metals, preferably sodium, potassium; alkaline earth metals, preferably magnesium, calcium, barium; metals of group 13 of the Periodic Table of the Elements, preferably aluminum; transition metals, preferably manganese, iron, cobalt, nickel, copper, zinc.

Examples of such anions are: halides and polyhalides, for example fluoride, chloride, bromide, iodide, triiodide; chalcogenides and polychalcogenides, for example oxide, hydroxide, sulfide, hydrogen sulfide, disulfide, trisulfide, tetrasulfide, pentasulfide, hexasulfide, selenide, telluride; pnicogenides, for example amide, imide, nitride, phosphide, arsenide; pseudohalides, for example cyanide, cyanate, thiocyanate; complex anions, for example phosphate, hydrogenphosphate, dihydrogenphosphate, sulfate, hydrogensulfate, sulfite, hydrogensulfite, thiosulfate, hexacyanoferrate, tetrachloroaluminate, tetrachloroferrate.

Examples of additives comprising anions are: aluminum(III) chloride, iron(III) chloride, iron(II) sulfide, sodium bromide, potassium bromide, sodium iodide, potassium iodide, potassium thiocyanate, sodium thiocyanate, disodium sulfide (Na₂S), disodium tetrasulfide (Na₂S₄), disodium pentasulfide (Na₂S₅), dipotassium pentasulfide (K₂S₅), dipotassium hexasulfide (K₂S₆), calcium tetrasulfide (CaS₄), barium trisulfide (BaS₃), dipotassium selenide (K₂Se), tripotassium phosphide (K₃P), potassium hexacyanoferrate(II), potassium hexacyanoferrate(III), copper(I) thiocyanate, potassium triiodide, cesium triiodide, sodium hydroxide, potassium hydroxide, cesium hydroxide, sodium oxide, potassium oxide, cesium oxide, potassium cyanide, potassium cyanate, sodium tetraaluminate, manganese(II) sulfide, cobalt(II) sulfide, nickel(II) sulfide, copper(II) sulfide, zinc sulfide, trisodium phosphate, disodium hydrogenphosphate, sodium dihydrogenphosphate, disodium sulfate, sodium hydrogensulfate, disodium sulfite, sodium hydrogensulfite, sodiumthiosulfate, tripotassium phosphate, dipotassium hydrogenphosphate, potassium dihydrogenphosphate, dipotassium sulfate, potassium hydrogensulfate, dipotassium sulfite, potassium hydrogensulfite, potassium thiosulfate.

Additives comprising anions in the context of this application are also mixtures of two or more compounds of a metal of the Periodic Table of the Elements with monoatomic or polyatomic, formally singly or multiply negatively charged anions, preferably anions formed from nonmetal atoms. According to the current state of knowledge, the ratio of the individual components is not critical in this context.

Particularly preferred additives comprising anions are alkali metal chalcogenides, for example binary compounds between an alkali metal, namely lithium, sodium, potasSium, rubidium or cesium, and a chalcogen, namely oxygen, sulfur, selenium or tellurium.

It will be appreciated that mixtures of these binary compounds are also possible, and the mixing ratios are not critical according to current knowledge.

Very particularly preferred additives comprising anions are disodium tetrasulfide (Na₂S₄), disodium pentasulfide (Na₂S₅), dipotassium pentasulfide (K₂S₅), dipotassium hexasulfide (K₂S₆), sodium thiocyanate (NaSCN), potassium thiocyanate (KSCN), sodium hydroxide (NaOH) or potassium hydroxide (KOH), and mixtures of at least two of these components.

Processes for preparing abovementioned additives comprising anions are known in principle and are described in the literature.

For example, it is possible to prepare alkali metal polysulfides of the formula M₂Sₓ (x=2, 3, 4, 5, 6) directly from the alkali metal sulfides and the appropriate amount of sulfur by co-melting at temperatures of 400 to 500° C. The corresponding alkali metal sulfides (M₂S) can be prepared, for example, by reducing the corresponding alkali metal sulfates with carbon. A further very suitable process for preparing alkali metal polysulfides is the direct reaction of alkali metals with sulfur, as described, for example, in U.S. Pat. No. 4,640,832. Further suitable processes for preparing the alkali metal polysulfides are the reaction of alkali metal carbonates or alkali metal hydroxides with sulfur, the reaction of alkali metal sulfides with sulfur, the reaction of alkali metal sulfides or alkali metal hydrogensulfides in aqueous or alcoholic solution with sulfur, or the reaction of alkali metals with sulfur in liquid ammonia.

The inventive mixture preferably comprises elemental sulfur in the range from 50 to 99.999% by weight, preferably in the range from 80 to 99.99% by weight, more preferably 90 to 99.9% by weight, based in each case on the total mass of the inventive mixture.

The inventive mixture preferably comprises additives comprising anions in the range from 0.001 to 50% by weight, preferably in the range from 0.01 to 20% by weight, more preferably 0.1 to 10% by weight, based in each case on the total mass of the inventive mixture.

The inventive mixture may comprise further additives, for example additives which lower the melting point of the mixture. In general, the total amount of these additives is in the range from 0.01 to 50% by weight, based on the total mass of the inventive mixture.

The sum of the components of the inventive mixture adds up to 100%.

The inventive mixture comprising elemental sulfur and an additive comprising anions, optionally a fluid inventive mixture (as defined below), may be prepared as follows.

All components (sulfur and an additive comprising anions or a plurality of additives comprising anions) are mixed with one another in the appropriate mass ratio in the solid state, and then optionally melted in order to obtain the finished fluid mixture.

Alternatively, the elemental sulfur is first melted, and an additive comprising anions or a plurality of additives comprising anions are added while mixing, and the resulting mixture is optionally converted to the solid state by cooling. The additive comprising anions or the additives comprising anions is/are preferably dissolved virtually completely in the sulfur melt.

The present application also provides the above-described inventive mixtures comprising elemental sulfur and an additive comprising anions in fluid form. These mixtures are referred to hereinafter as “fluid inventive mixtures”.

The term “fluid inventive mixture” herein means that the sulfur in this mixture is present at least partly, preferably completely, in fluid form at pressure 101325 Pa (abs.) or even higher pressure.

The fluid inventive mixture preferably has a temperature in the range from 120° C. to 450° C. at a pressure of 101325 Pa (abs.). Under a higher pressure than 101325 Pa (abs.), the fluid inventive mixture preferably has a temperature in the range from 120° C. to 600° C.

In terms of composition, the fluid inventive mixture corresponds to the inventive mixtures described above in principle or as preferred, particularly preferred or very particularly preferred, comprising elemental sulfur and an additive comprising anions.

The maximum viscosity of the fluid inventive mixture is generally in the range from 0.005 Pa·s to 50 Pa·s, preferably 0.005 Pa·s to 30 Pa·s, more preferably 0.005 Pa·s to 5 Pa·s, within the temperature range from 120° C. to 195° C., measured at a pressure of 101325 Pa (abs.), as specified in the examples.

The application further relates to the use of a mixture comprising elemental sulfur and an additive comprising anions, preferably of a fluid inventive mixture, in each case as described above, as a heat carrier and/or heat accumulator.

The application further relates to the use of a mixture comprising elemental sulfur and an additive comprising anions, preferably of a fluid inventive mixture, in each case as described above, as a heat carrier and/or heat accumulator in power plants, for example solar thermal power plants.

The application further relates to the use of a mixture comprising elemental sulfur and an additive comprising anions, preferably of a fluid inventive mixture, in each case as described above, as a heat carrier and/or heat accumulator in power plants, for example solar thermal power plants, at a temperature in the range from 120° C. to 600° C.

The above-described use of the fluid inventive mixtures, especially that as a heat carrier, preferably takes place with exclusion of air and moisture, preferably in a closed system composed, for example, of pipelines, pumps, heat exchangers, control devices and vessels.

The present application further provides heat carriers or heat accumulators which comprise a mixture, preferably in fluid form, comprising elemental sulfur and an additive comprising anions.

Heat carriers are media which are heated by a heat source, for example the sun in solar thermal power plants, and transport the amount of heat present therein over a particular distance. They can then transfer this heat to another medium, for example water or a gas, preferably by means of heat exchangers, in which case this other medium may then, for example, drive a turbine. Heat carriers may also transfer the amount of heat present therein to another medium present in a reservoir vessel (for example potassium nitrate-sodium nitrate salt melt), and thus pass on the heat to storage. Heat carriers can also themselves be introduced into a reservoir vessel and remain there; in that case, they are themselves both heat carriers and heat accumulators.

Heat accumulators are media, typically material compositions, for example the inventive mixtures, which can store an amount of heat over a certain time and are typically within an immobile vessel, preferably insulated against heat loss.

The present application further provides solar thermal power plants comprising pipelines, heat exchangers and/or vessels filled with mixtures comprising elemental sulfur and an additive comprising anions.

### EXAMPLES

The physical properties were measured as follows:

The dynamic viscosity of the mixtures was determined within a temperature range from 120 to 195° C. by means of rotational viscometry according to an in-house method, as follows. The test setup consists of a stationary cylindrical vessel in which there is a solid cylinder mounted so as to be rotatable. The fluid to be analyzed is introduced into the annular gap. Subsequently, the torque required to allow the solid cylinder to rotate at a particular speed is determined. The torque required, as a function of the speed gradient which occurs, can be used to calculate the dynamic viscosity of the fluid.

### Example 1 (General method)

The particular mixture as described in examples 2 to 6 was heated from room temperature to 250° C. in a nitrogen atmosphere while stirring. From approx. 120° C., the mixture became liquid. In the course of further heating, from approx. 159° C., the starting viscosity increased significantly, reached a maximum at approx. 190° C. and then fell again at even higher temperature, as was found by the change in the stirrer torque. The mixture was allowed to cool from 250° C. to 150° C.

This heating and cooling operation was carried out nine times more. Then a sample of the mixture was taken at room temperature, and the dynamic viscosity of the sample was determined as described above.

### Example 2

Example 1 was carried out with a mixture of 3 g of dipotassium pentasulfide (K₂S₅) and 297 g of sulfur, and the dynamic viscosity of a sample was measured. The viscosity maximum was at 195° C. and was 5 Pa·s.

### Example 3

Example 1 was carried out with a mixture of 5 g of potassium hydroxide (KOH) and 295 g of sulfur, and the dynamic viscosity of a sample was measured. The viscosity maximum was at 195° C. and was 5 Pa·s.

### Example 4

Example 1 was carried out with a mixture of 5 g of sodium hydroxide (NaOH) and 295 g of sulfur, and the dynamic viscosity of a sample was measured. The viscosity maximum was at 195° C. and was 30 Pa·s.

### Example 5

Example 1 was carried out with a mixture of 3 g of disodium pentasulfide (Na2S5) and 297 g of sulfur, and the dynamic viscosity of a sample was measured. The viscosity maximum was at 195° C. and was 10 Pa·s.

### Example 6

Example 1 was carried out with a mixture of 15 g of iron(III) chloride (FeCl3) and 285 g of sulfur, and the dynamic viscosity of a sample was measured. The viscosity maximum was at 195° C. and was 38 Pa·s.

### Example 7 (for comparison)

Example 1 was repeated with 300 g of sulfur, and no additive comprising anions was added.

As described in example 1, the sulfur was heated and cooled a total of ten times.

Then a sample of the mixture was taken at room temperature, and the dynamic viscosity was determined as described above. The viscosity maximum was at 190° C. and was 90 Pa·s.

1.-11. (canceled)

12. A mixture comprising elemental sulfur and an additive comprising anions.

13. The mixture according to claim 12, wherein the additive comprising anions comprises ionic compounds of a metal of the Periodic Table of the Elements with monoatomic or polyatomic, singly or multiply negatively charged anions.

14. The mixture according to claim 12 in fluid form.

15. The mixture according to claim 13 in fluid form.

16. The mixture according to claim 14 having a maximum viscosity in the range from 0.005 Pa·s to 50 Pa·s in the temperature range from 120° C. to 195° C. at a pressure of 101326 Pa (abs.).

17. The mixture according to claim 15 having a maximum viscosity in the range from 0.005 Pa·s to 50 Pa·s in the temperature range from 120° C. to 195° C. at a pressure of 101326 Pa (abs.).

18. A heat carrier and/or heat accumulator which comprises the mixture as defined in claim 12.

19. A heat carrier and/or heat accumulator which comprises the mixture as defined in claim 17 in fluid form.

20. A power plant which comprises the heat carrier and/or heat accumulator as claimed in claim 18.

21. A solar thermal power plant comprising pipelines, heat exchangers and/or vessels filled with the mixture as claimed in claim 12.

22. A process for preparing a mixture comprising elemental sulfur and an additive comprising anions, wherein
i) elemental sulfur and an additive comprising anions or a plurality of additives comprising anions are mixed with one another in the desired mass ratio in the solid state, and the mixture is optionally then converted to a melt by heating, or
ii) wherein the elemental sulfur is first melted and an additive comprising anions or a plurality of additives comprising anions are added thereto while mixing, and the resulting mixture is optionally converted to the solid state by cooling.
